(19) United States
(12) Patent Application Publication
(10) Pub. No.: US 2009/0225034 A1
(43) Pub. Date: Sep. 10, 2009

(54) Japanese-Language Virtual Keyboard

(76) Inventors: Yasuo Kida, Palo Alto, CA (US); Takumi Takano, Tokyo (JP); Shin Nishibori, Portola Valley, CA (US)

Correspondence Address: MORGAN LEWIS & BOCKIUS LLP/ AI, 2 PALO ALTO SQUARE, 3000 EL CAMINO REAL, PALO ALTO, CA, 94306, US

(21) Appl. No.: 12/268,306

(22) Filed: Nov. 10, 2008

Related U.S. Application Data
(60) Provisional application No. 61/033,781, filed on Mar. 4, 2008.

(51) Int. Cl. G06F 3/02

(52) U.S. Cl. 345/171

(57) ABSTRACT

Methods, systems, and apparatus, including computer program products, for inputting text. A virtual keyboard is presented in a first region on a touch sensitive display of a device, where the keyboard includes a key for each of a plurality of Japanese kana symbols. An input selecting one or more of the kana keys is received. The kana symbols corresponding to the selected keys are presented in a second region on the touch sensitive display.

### RELATED APPLICATION

This application claims priority to U.S. Provisional Application No. 61/033,781, “Japanese-Language Virtual Keyboard,” filed Mar. 4, 2008, which is incorporated by reference herein in its entirety.

### BACKGROUND

The subject matter of this specification is related generally to text input interfaces.

Traditional computer keyboards may be too large for portable devices, such as mobile phones, multimedia players, or personal digital assistants (PDAs). Some portable devices include a smaller version of the traditional computer keyboard or use a virtual keyboard to receive user input. A virtual keyboard can be of the form of a software application or a feature of a software application to simulate a computer keyboard. For example, in a portable device with a touch-sensitive display, a virtual keyboard can be used by a user to input text by selecting or tabbing areas of the touch-sensitive display corresponding to keys of the virtual keyboard.

These smaller keyboards and virtual keyboards may have keys that correspond to more than one character. For example, some of the keys can, by default, correspond to a character in the English language, for example, the letter “a,” and may also correspond to other additional characters, such as another letter or the letter with an accent option, e.g., the character “ä,” or other characters with accent options. Because of the physical limitations (e.g., size) of the virtual keyboard, a user may find it difficult to type characters not readily available on the virtual keyboard.

Input methods for devices having multi-language environments can present unique challenges with respect to input and spelling correction which may need to be tailored to the selected language to ensure accuracy and an efficient workflow.

### SUMMARY

In general, one aspect of the subject matter described in this specification can be embodied in methods that include the actions of presenting a virtual keyboard in a first region on a touch sensitive display of a device, where the keyboard comprises a key for each of a plurality of Japanese kana symbols; receiving an input selecting one or more of the kana keys; and presenting the kana symbols corresponding to the selected keys in a second region on the touch sensitive display. Other embodiments of this aspect include corresponding systems, apparatus, computer program products, and computer readable media.

Particular embodiments of the subject matter described in this specification can be implemented to realize one or more of the following advantages. Users who are unfamiliar with Japanese romanization can enter Japanese text on a portable device without having to use a Latin alphabet keyboard.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example mobile device.

FIG. 2 is a block diagram of an example implementation of the mobile device of FIG. 1.

FIG. 3 illustrates an example user interface for entering Japanese text.

FIG. 4 illustrates an example process for entering text using a Japanese kana keyboard.

Like reference numbers and designations in the various drawings indicate like elements.

### DETAILED DESCRIPTION

### Example Mobile Device

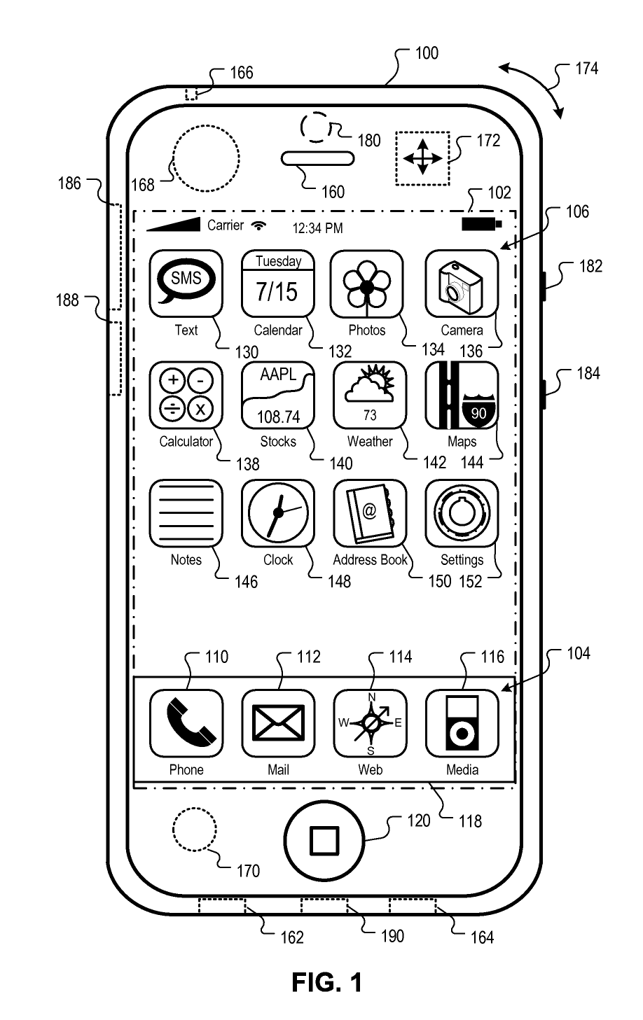

FIG. 1 is a block diagram of an example mobile device 100. The mobile device 100 can be, for example, a handheld computer, a personal digital assistant, a cellular telephone, a network appliance, a camera, a smart phone, an enhanced general packet radio service (EGPRS) mobile phone, a network base station, a media player, a navigation device, an email device, a game console, or a combination of any two or more of these data processing devices or other data processing devices.

### Mobile Device Overview

In some implementations, the mobile device 100 includes a touch-sensitive display 102. The touch-sensitive display 102 can implement liquid crystal display (LCD) technology, light emitting polymer display (LPD) technology, or some other display technology. The touch sensitive display 102 can be sensitive to haptic and/or tactile contact with a user.

In some implementations, the touch-sensitive display 102 can comprise a multi-touch-sensitive display 102. A multi-touch-sensitive display 102 can, for example, process multiple simultaneous touch points, including processing data related to the pressure, degree, and/or position of each touch point. Such processing facilitates gestures and interactions with multiple fingers, chording, and other interactions. Other touch-sensitive display technologies can also be used, e.g., a display in which contact is made using a stylus or other pointing device. Some examples of multi-touch-sensitive display technology are described in U.S. Pat. Nos. 6,323,846, 6,570,557, 6,677,932, and 6,888,536, each of which is incorporated by reference herein in its entirety.

In some implementations, the mobile device 100 can display one or more graphical user interfaces on the touch-sensitive display 102 for providing the user access to various system objects and for conveying information to the user. In some implementations, the graphical user interface can include one or more display objects 104, 106. In the example shown, the display objects 104, 106, are graphic representations of system objects. Some examples of system objects include device functions, applications, windows, files, alerts, events, or other identifiable system objects.

### Example Mobile Device Functionality

In some implementations, the mobile device 100 can implement multiple device functionalities, such as a telephony device, as indicated by a phone object 110; an e-mail device, as indicated by the e-mail object 112; a network data communication device, as indicated by the Web object 114; a Wi-Fi base station device (not shown); and a media processing device, as indicated by the media player object 116. In some implementations, particular display objects 104, e.g., the phone object 110, the e-mail object 112, the Web object 114, and the media player object 116, can be displayed in a menu bar 118. In some implementations, device functionalities can be accessed from a top-level graphical user interface, such as the graphical user interface illustrated in FIG. 1. Touching one of the objects 110, 112, 114, or 116 can, for example, invoke corresponding functionality.

In some implementations, the mobile device 100 can implement network distribution functionality. For example, the functionality can enable the user to take the mobile device 100 and provide access to its associated network while traveling. In particular, the mobile device 100 can extend Internet access (e.g., Wi-Fi) to other wireless devices in the vicinity. For example, mobile device 100 can be configured as a base station for one or more devices. As such, mobile device 100 can grant or deny network access to other wireless devices.

In some implementations, upon invocation of device functionality, the graphical user interface of the mobile device 100 changes, or is augmented or replaced with another user interface or user interface elements, to facilitate user access to particular functions associated with the corresponding device functionality. For example, in response to a user touching the phone object 110, the graphical user interface of the touch-sensitive display 102 may present display objects related to various phone functions; likewise, touching of the email object 112 may cause the graphical user interface to present display objects related to various e-mail functions; touching the Web object 114 may cause the graphical user interface to present display objects related to various Web-surfing functions; and touching the media player object 116 may cause the graphical user interface to present display objects related to various media processing functions.

In some implementations, the top-level graphical user interface environment or state of FIG. 1 can be restored by pressing a button 120 located near the bottom of the mobile device 100. In some implementations, each corresponding device functionality may have corresponding “home” display objects displayed on the touch-sensitive display 102, and the graphical user interface environment of FIG. 1 can be restored by pressing the “home” display object.

In some implementations, the top-level graphical user interface can include additional display objects 106, such as a short messaging service (SMS) object 130, a calendar object 132, a photos object 134, a camera object 136, a calculator object 138, a stocks object 140, a weather object 142, a maps object 144, a notes object 146, a clock object 148, an address book object 150, and a settings object 152. Touching the SMS display object 130 can, for example, invoke an SMS messaging environment and supporting functionality; likewise, each selection of a display object 132, 134, 136, 138, 140, 142, 144, 146, 148, 150, and 152 can invoke a corresponding object environment and functionality.

Additional and/or different display objects can also be displayed in the graphical user interface of FIG. 1. For example, if the device 100 is functioning as a base station for other devices, one or more “connection” objects may appear in the graphical user interface to indicate the connection. In some implementations, the display objects 106 can be configured by a user, e.g., a user may specify which display objects 106 are displayed, and/or may download additional applications or other software that provides other functionalities and corresponding display objects.

In some implementations, the mobile device 100 can include one or more input/output (I/O) devices and/or sensor devices. For example, a speaker 160 and a microphone 162 can be included to facilitate voice-enabled functionalities, such as phone and voice mail functions. In some implementations, an up/down button 184 for volume control of the speaker 160 and the microphone 162 can be included. The mobile device 100 can also include an on/off button 182 for a ring indicator of incoming phone calls. In some implementations, a loud speaker 164 can be included to facilitate hands-free voice functionalities, such as speaker phone functions. An audio jack 166 can also be included for use of headphones and/or a microphone.

In some implementations, a proximity sensor 168 can be included to facilitate the detection of the user positioning the mobile device 100 proximate to the user's ear and, in response, to disengage the touch-sensitive display 102 to prevent accidental function invocations. In some implementations, the touch-sensitive display 102 can be turned off to conserve additional power when the mobile device 100 is proximate to the user's ear.

Other sensors can also be used. For example, in some implementations, an ambient light sensor 170 can be utilized to facilitate adjusting the brightness of the touch-sensitive display 102. In some implementations, an accelerometer 172 can be utilized to detect movement of the mobile device 100, as indicated by the directional arrow 174. Accordingly, display objects and/or media can be presented according to a detected orientation, e.g., portrait or landscape. In some implementations, the mobile device 100 may include circuitry and sensors for supporting a location determining capability, such as that provided by the global positioning system (GPS) or other positioning systems (e.g., systems using Wi-Fi access points, television signals, cellular grids, Uniform Resource Locators (URLs)). In some implementations, a positioning system (e.g., a GPS receiver) can be integrated into the mobile device 100 or provided as a separate device that can be coupled to the mobile device 100 through an interface (e.g., port device 190) to provide access to location-based services.

In some implementations, a port device 190, e.g., a Universal Serial Bus (USB) port, or a docking port, or some other wired port connection, can be included. The port device 190 can, for example, be utilized to establish a wired connection to other computing devices, such as other communication devices 100, network access devices, a personal computer, a printer, a display screen, or other processing devices capable of receiving and/or transmitting data. In some implementations, the port device 190 allows the mobile device 100 to synchronize with a host device using one or more protocols, such as, for example, the TCP/IP, HTTP, UDP and any other known protocol.

The mobile device 100 can also include a camera lens and sensor 180. In some implementations, the camera lens and sensor 180 can be located on the back surface of the mobile device 100. The camera can capture still images and/or video.

The mobile device 100 can also include one or more wireless communication subsystems, such as an 802.11b/g communication device 186, and/or a Bluetooth™ communication device 188. Other communication protocols can also be supported, including other 802.x communication protocols (e.g., WiMax, Wi-Fi, 3 G), code division multiple access (CDMA), global system for mobile communications (GSM), Enhanced Data GSM Environment (EDGE), etc.

### Example Mobile Device Architecture

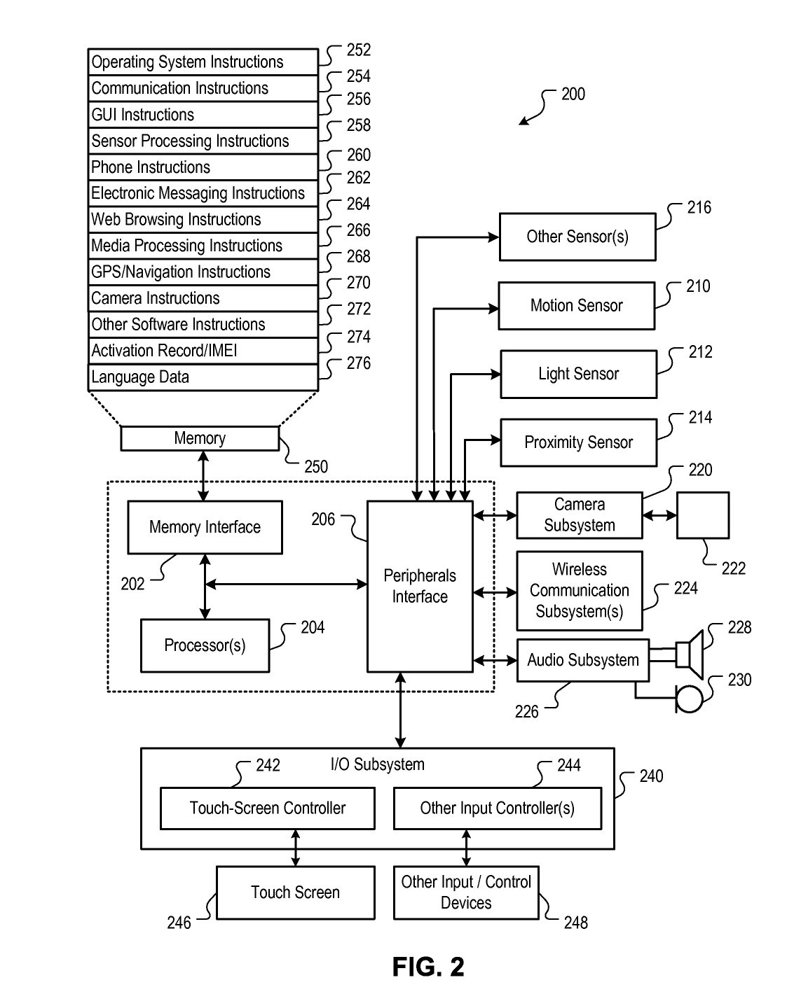

FIG. 2 is a block diagram 200 of an example implementation of the mobile device 100 of FIG. 1. The mobile device 100 can include a memory interface 202, one or more data processors, image processors and/or central processing units 204, and a peripherals interface 206. The memory interface 202, the one or more processors 204 and/or the peripherals interface 206 can be separate components or can be integrated in one or more integrated circuits. The various components in the mobile device 100 can be coupled by one or more communication buses or signal lines.

Sensors, devices, and subsystems can be coupled to the peripherals interface 206 to facilitate multiple functionalities. For example, a motion sensor 210, a light sensor 212, and a proximity sensor 214 can be coupled to the peripherals interface 206 to facilitate the orientation, lighting, and proximity functions described with respect to FIG. 1. Other sensors 216 can also be connected to the peripherals interface 206, such as a positioning system (e.g., GPS receiver), a temperature sensor, a biometric sensor, or other sensing device, to facilitate related functionalities.

A camera subsystem 220 and an optical sensor 222, e.g., a charged coupled device (CCD) or a complementary metal-oxide semiconductor (CMOS) optical sensor, can be utilized to facilitate camera functions, such as recording photographs and video clips.

Communication functions can be facilitated through one or more wireless communication subsystems 224, which can include radio frequency receivers and transmitters and/or optical (e.g., infrared) receivers and transmitters. The specific design and implementation of the communication subsystem 224 can depend on the communication network(s) over which the mobile device 100 is intended to operate. For example, a mobile device 100 may include communication subsystems 224 designed to operate over a GSM network, a GPRS network, an EDGE network, a Wi-Fi or WiMax network, and a Bluetooth™ network. In particular, the wireless communication subsystems 224 may include hosting protocols such that the device 100 may be configured as a base station for other wireless devices.

An audio subsystem 226 can be coupled to a speaker 228 and a microphone 230 to facilitate voice-enabled functions, such as voice recognition, voice replication, digital recording, and telephony functions.

The I/O subsystem 240 can include a touch screen controller 242 and/or other input controller(s) 244. The touch-screen controller 242 can be coupled to a touch screen 246. The touch screen 246 and touch screen controller 242 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 246.

The other input controller(s) 244 can be coupled to other input/control devices 248, such as one or more buttons, rocker switches, thumb-wheel, infrared port, USB port, and/or a pointer device such as a stylus. The one or more buttons (not shown) can include an up/down button for volume control of the speaker 228 and/or the microphone 230.

In one implementation, a pressing of the button for a first duration may disengage a lock of the touch screen 246; and a pressing of the button for a second duration that is longer than the first duration may turn power to the mobile device 100 on or off. The user may be able to customize a functionality of one or more of the buttons. The touch screen 246 can, for example, also be used to implement virtual or soft buttons and/or a keyboard.

In some implementations, the mobile device 100 can present recorded audio and/or video files, such as MP3, AAC, and MPEG files. In some implementations, the mobile device 100 can include the functionality of an MP3 player, such as an iPod™. The mobile device 100 may, therefore, include a 30-pin connector that is compatible with the iPod3. Other input/output and control devices can also be used.

The memory interface 202 can be coupled to memory 250. The memory 250 can include high-speed random access memory and/or non-volatile memory, such as one or more magnetic disk storage devices, one or more optical storage devices, and/or flash memory (e.g., NAND, NOR). The memory 250 can store an operating system 252, such as Darwin, RTXC, LINUX, UNIX, OS X, WINDOWS, or an embedded operating system such as VxWorks. The operating system 252 may include instructions for handling basic system services and for performing hardware dependent tasks. In some implementations, the operating system 252 can be a kernel (e.g., UNIX kernel).

The memory 250 may also store communication instructions 254 to facilitate communicating with one or more additional devices, one or more computers and/or one or more servers. The memory 250 may include graphical user interface instructions 256 to facilitate graphic user interface processing; sensor processing instructions 258 to facilitate sensor-related processing and functions; phone instructions 260 to facilitate phone-related processes and functions; electronic messaging instructions 262 to facilitate electronic-messaging related processes and functions; web browsing instructions 264 to facilitate web browsing-related processes and functions; media processing instructions 266 to facilitate media processing-related processes and functions; GPS/Navigation instructions 268 to facilitate GPS and navigation-related processes and instructions; camera instructions 270 to facilitate camera-related processes and functions; and/or other software instructions 272 to facilitate other processes and functions, e.g., security processes and functions. The memory 250 may also store other software instructions (not shown), such as web video instructions to facilitate web video-related processes and functions; and/or web shopping instructions to facilitate web shopping-related processes and functions. In some implementations, the media processing instructions 266 are divided into audio processing instructions and video processing instructions to facilitate audio processing-related processes and functions and video processing-related processes and functions, respectively. An activation record and International Mobile Equipment Identity (IMEI) 274 or similar hardware identifier can also be stored in memory 250.

Language data 276 can also be stored in memory 250. Language data 276 can include, for example, word dictionaries (i.e., list of possible words in a language) for one or more languages, dictionaries of characters and corresponding phonetics, one or more corpuses of characters and character compounds, and so on.

Each of the above identified instructions and applications can correspond to a set of instructions for performing one or more functions described above. These instructions need not be implemented as separate software programs, procedures, or modules. The memory 250 can include additional instructions or fewer instructions. Furthermore, various functions of the mobile device 100 may be implemented in hardware and/or in software, including in one or more signal processing and/or application specific integrated circuits.

### Japanese-Language Keyboard

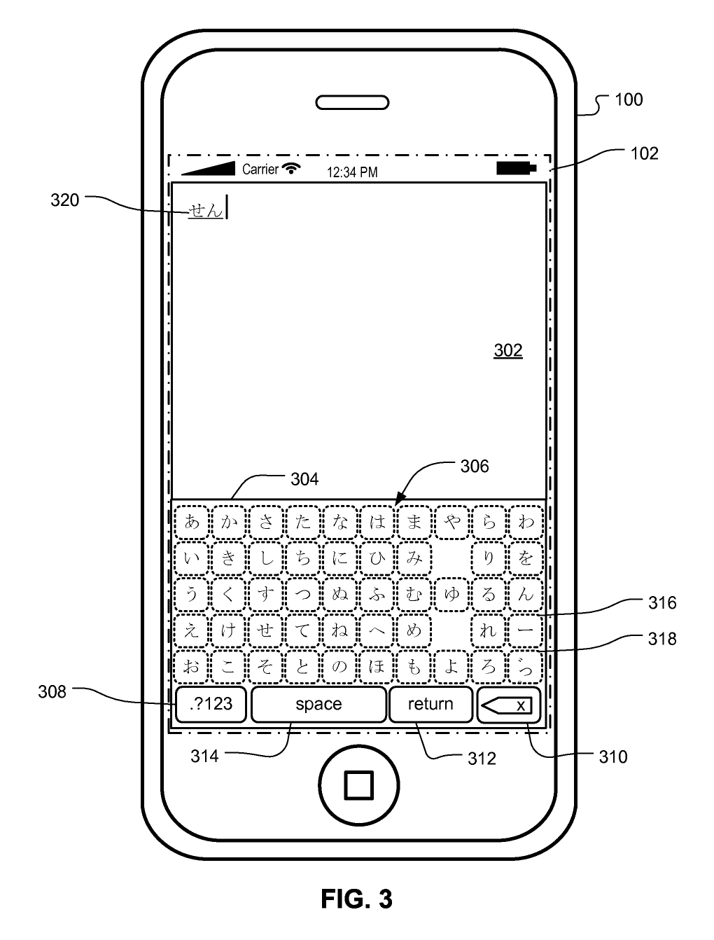

FIG. 3 illustrates an example user interface for entering Japanese text on mobile device 100, including a Japanese-language keyboard. Mobile device 100 can display a text input area 302 and a virtual keyboard 304 on the touch-sensitive display 102. The text input area 302 can be any area where input text can be displayed, e.g., a note-taking application, an email application, and so on.

The virtual keyboard 304 includes keys 306 for basic phonetic sounds in Japanese, which are represented by kana symbols. For convenience, the keys 306 will be referred to below as “kana” keys 306. The kana keys 306 can include a key for each of 46 basic sounds in Japanese, as shown in FIG. 3. When a user hits a kana key 306, a kana symbol corresponding to the hit key can be entered. For example, hitting the “ [symbol] ” key enters the hiragana symbol “ [symbol] ”.

The virtual keyboard 304 can also include a vowel extender key 316, and a sound modifier key 318. The vowel extender key 316 can be used to enter a chōon mark for indicating long vowels (e.g., when entering text that are to be displayed in katakana). The sound modifier key 318 can be used to modify entered kana symbols to indicate modified voicing. In some implementations, after a user hits a kana key 306, the user can hit the sound modifier key 318 to add a dakuten or handakuten diacritic mark (e.g., to enter the kana symbols [symbol] etc.) or change an entered kana symbol to its small versions (e.g., small versions of the vowel kana and [symbol] for entering yōon or sokuon.

In some implementations, the virtual keyboard 304 includes a keyboard toggle key 308 for toggling between kana keys and keys for numbers, punctuation, etc. (i.e., either kana keys or numbers/punctuation keys can be displayed in the virtual keyboard 304). The keyboard 304 can also include a delete/backspace key 310, a space key 314, and a return key 312. In some implementations, the virtual keyboard 304 also includes a keyboard switching key (not shown) for switching between virtual keyboards or text entry interfaces for various languages.

The kana symbols entered by the user using the virtual keyboard 304 can be displayed in the text input area 302 as the current input 320. The current input 320 can be displayed with underlining to indicate that the input is provisional and subject to the user's acceptance. The device 100 can identify one or more candidates for conversion of the current input 320 and present the candidates to the user. The candidates can include single kanji characters, single kana symbols, romanization, and words or phrases formed from combinations of kanji and/or kana. In some implementations, the identified candidates include words or phrases that begin with the current input and/or kanji whose reading is or begins with the current input. The user can select one of the candidates (e.g., by touching the touch-sensitive display over one of the candidates). The device 100 receives the user input selecting the candidate, and the current input 320 can be replaced with the selected candidate.

In some implementations, when the user hits the kana keys 306, hiragana symbols are entered by default. Katakana equivalents of the entered symbols can be presented as one of the candidates for selection by the user.

In some implementations, the kana keys 306 are in gojūon order oriented from left to right, as shown in FIG. 3. In some other implementations, the kana keys 306 are in gojūon order oriented from right to left.

In some implementations, columns of kana keys 306 can alternate in key color or shading or background color, to provide visual contrast between the columns of keys. For example, in FIG. 3 the [symbol] column of keys can have a first background color, the [symbol] column of keys can have a second background color, the [symbol] column of keys can have the first background color, the [symbol] column of keys can have the second background color, and so on. The alternating coloring/shading provides differentiations between keys for different consonants.

In some implementations, the candidates are identified and ordered using predictive text and/or error correction techniques, examples of which include fuzzy matching, techniques for determining cursor position based on a finger contact, and so on. An example of a predictive text technique is disclosed in Masui, “An Efficient Text Input Method for Pen-based Computers,” in Proceedings of the ACM Conference on Human Factors in Computing Systems (CHI '98), Addison-Wesley, April 1998, pp. 328-335, the disclosure of which is incorporated by reference herein in its entirety. An example of a technique for determining cursor position based on a finger contact is disclosed in U.S. patent application Ser. No. 11/850,015, titled “Methods for Determining a Cursor Position from a Finger Contact with a Touch Screen Display,” filed Sep. 4, 2007, the disclosure of which is incorporated by reference herein in its entirety.

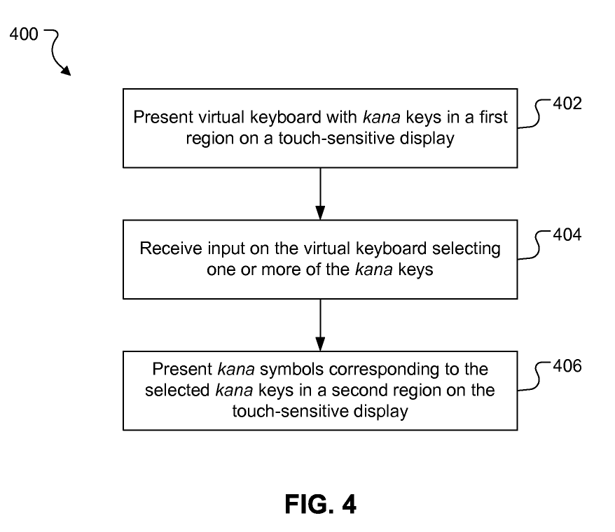

FIG. 4 illustrates an example process 400 for entering text using a Japanese kana keyboard. For convenience, the process 400 will be described in reference to a device that performs the process (e.g., device 100).

A virtual keyboard with Japanese kana keys is presented in a first region on a touch-sensitive display (402). In some implementations, the virtual keyboard can include a set of multiple keys, each of them corresponding to a Japanese sound or syllable that is represented by a kana symbol.

Input is received (e.g., on the keyboard) selecting one or more of the kana keys (404). For example, a user can select (i.e., hit) one or more of the kana keys on the virtual keyboard to enter the corresponding kana symbols.

Kana symbols corresponding to the selected kana keys can be presented in a second region of the touch-sensitive display (406). For example, the entered kana symbols can be displayed in a text input area 302 on the touch-sensitive display, for example.

The disclosed and other embodiments and the functional operations described in this specification can be implemented in digital electronic circuitry, or in computer software, firmware, or hardware, including the structures disclosed in this specification and their structural equivalents, or in combinations of one or more of them. The disclosed and other embodiments can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the disclosed embodiments can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The disclosed embodiments can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of what is disclosed here, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

While this specification contains many specifics, these should not be construed as limitations on the scope of what being claims or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understand as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method comprising:
presenting a virtual keyboard in a first region on a touch-sensitive display of a device, the keyboard comprising a key for each of a plurality of Japanese kana symbols;
receiving an input selecting one or more of the kana keys; and
presenting the kana symbols corresponding to the selected keys in a second region on the touch-sensitive display.

2. The method of claim 1, wherein the virtual keyboard further comprises a sound modifier key.

3. The method of claim 1, further comprising:
presenting one or more candidates for the presented kana symbols;
receiving an input selecting one of the candidates; and
replacing the presented kana symbols with the selected candidate.

4. The method of claim 3, wherein the candidates comprise one or more of the group consisting of: single kanji characters, single kana symbols, romanization, and combinations of kanji and kana.

5. The method of claim 1, wherein the presented kana symbols are hiragana symbols.

6. The method of claim 1, wherein the kana keys are ordered in gojūon order from left to right.

7. The method of claim 1, wherein the kana keys are ordered in gojūon order from right to left.

8. The method of claim 1, wherein the kana keys are arranged in a plurality of columns, and the columns of kana keys alternate column-to-column in one or more of color, shading, or background color.

9. A user interface on a touch-sensitive display, the user interface comprising:
a text input area; and
a virtual keyboard, the virtual keyboard comprising a key for each of a plurality of Japanese kana symbols;
wherein kana symbols corresponding to kana keys selected by a user are presented in the text input area.

10. A computer program product, encoded on a tangible program carrier, operable to cause a portable device to perform operations comprising:
presenting a virtual keyboard in a first region on a touch-sensitive display of a device, the keyboard comprising a key for each of a plurality of Japanese kana symbols;
receiving an input selecting one or more of the kana keys; and
presenting the kana symbols corresponding to the selected keys in a second region on the touch-sensitive display.

11. A portable device comprising:
a touch-sensitive display;
memory;
one or more processors; and
instructions stored in the memory and configured for execution by the one or more processors, the instructions comprising instructions to:
present a virtual keyboard in a first region on a touch-sensitive display of a device, the keyboard comprising a key for each of a plurality of Japanese kana symbols;
receive an input selecting one or more of the kana keys; and
present the kana symbols corresponding to the selected keys in a second region on the touch-sensitive display.
